(19) United States
(12) Patent Application Publication
(10) Pub. No.: US 2009/0228387 A1
(43) Pub. Date: Sep. 10, 2009

(54) SYSTEM AND METHOD FOR FILING, SEARCHING, RANKING AND AUCTIONING INTELLECTUAL PROPERTY

(75) Inventors: Kristina M. Johnson, Baltimore, MD (US); Jean F. Sullivan, Woodside, CA (US); Robert L. Clark, JR., Chapel Hill, NC (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SPARKIP, Atlanta, GA (US)

(21) Appl. No.: 12/093,682

(22) PCT Filed: Nov. 14, 2006
(86) PCT No.: PCT/US2006/044239

§ 371 Date: Feb. 12, 2009

Related U.S. Application Data
(60) Provisional application No. 60/735,821, filed on Nov. 14, 2005.

(51) Int. Cl. G06Q 40/00; G06Q 50/00

(52) U.S. Cl. 705/37

(57) ABSTRACT

A system accessible by a user via the internet that includes a functional search and analysis system, an e-inventor's notebook operatively coupled to said functional search and analysis system, wherein the functional search and analysis system, the e-inventor's notebook and the IP market place and accessible by users from the internet and provide the user tools and a platform to develop IP and/or sell or purchase partial interests or entire interests in IP assets.

### BACKGROUND OF THE INVENTION

1. Field of the Invention

The invention relates to a system and method for protecting intellectual property and facilitating intellectual property transactions, and, more particularly, to a system and method for filing, searching, ranking and auctioning intellectual property.

2. Background of the Related Art

Although there may be systems that provide auctions to buy or sell IP assets, they do not provide a system and method for creating intellectual property (IP) assets, buying, selling or trading IP assets, valuing IP assets including underlying technology and the strength of provisional and utility applications.

### BRIEF DESCRIPTION OF THE DRAWINGS

The invention will be described in detail with reference to the following drawings in which like reference numerals refer to like elements, wherein:

FIG. 1 shows a system 101, according to an embodiment of the present invention.

FIG. 2 shows system 101 which includes a functional search and analysis system 501 on inventors notebook 205 and an IP market place 209.

FIG. 3 shows tic interactive electronic inventors notebook 301.

FIG. 4 is a block diagram of the IP marketplace 209, according to an embodiment of the invention.

FIG. 5 is a block diagram of a functional search and analysis system 501, according to an embodiment of the invention.

FIG. 6 is a diagram showing exemplary functional relationships available to users of system 601.

### DETAILED DESCRIPTION OF PREFERRED EMBODIMENTS

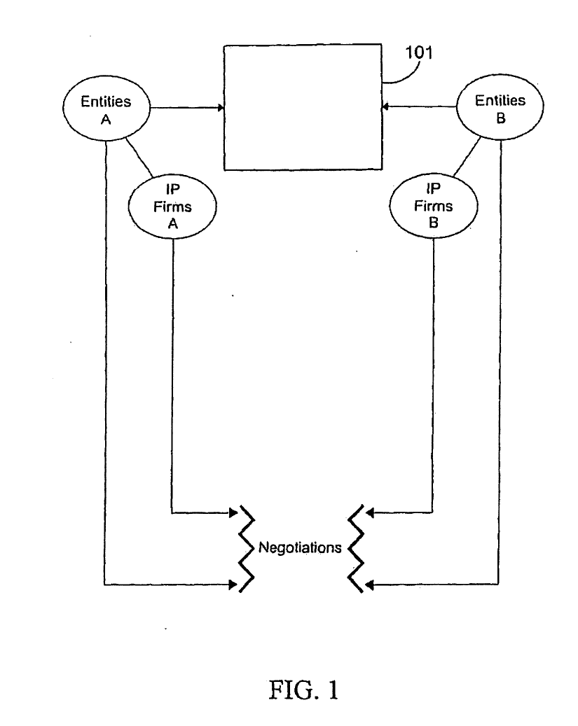

FIG. 1 shows a system 101, according to an embodiment of the present Invention. Entities A include potential IP asset creators and/or IP asset transferors, such as, for example, individuals, universities, companies, research institutions, venture capital groups and investment banking groups. Entities B include potential IP asset purchasers and/or licensors, IP asset users, IP asset traders and/or IP asset speculators, such as, for example, individual investors, venture capital groups, companies, universities, investment bankers, and intellectual property traders. It should be understood that the entities A and B are exemplary, and Include other entities known in the art which could utilize system 101 to create and/or transfer IP assets or use system 101 to purchase IP assets, license IP assets, trade IP assets or speculate in IP assets.

Referring to FIG. 1, entities A preferably access system 101 via a distributed network, such as the internet, in order to accomplish multiple tasks. In accordance with one embodiment of the invention, entities A can access system 101 in order to create an electronic inventor's notebook in order to provide guidance in development of the inventor's concepts and develop and establish the potential value of the technology as it's being developed. In particular, system 101 provides market valuation information to entities A. In addition, entities A can access system 101 in order to develop and draft provisional patent applications, as well as design and/or utility patent applications. System 101 provides entities A with interactive feedback information regarding the potential strength of the IP. This would include, for example, an indication of the probability or likelihood that a patent application will or will not issue to a utility patent.

FIG. 1 further shows IP firms A and IP firms B, which represent IP firms accessible from system 101 and capable of assisting entities A or B at any point during the transaction or process. IP firms A and B may pay an advertising fee to advertise on system's 101 website.

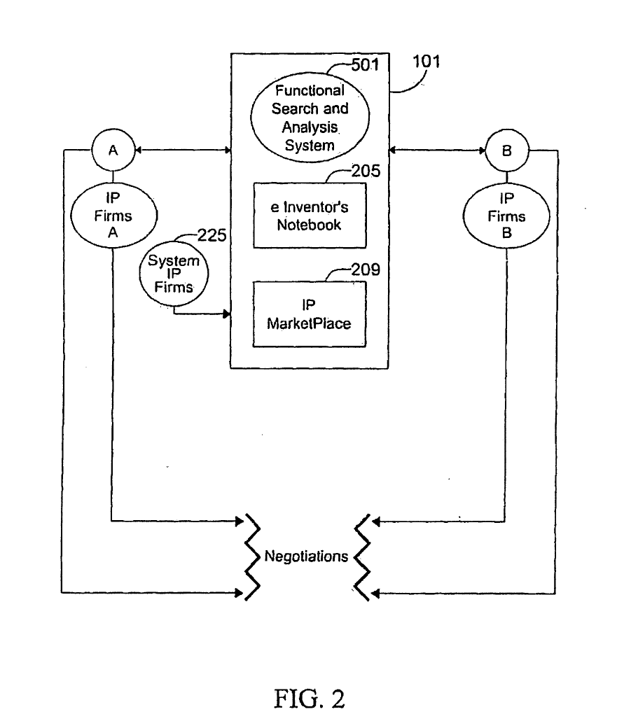

FIG. 2 shows system 101 which includes a functional search and analysis system 501 on inventors notebook 205 and an IP market place 209. System IP firms 225 provide services via system 101 to entities A or entities B. Internal conflicts checks shall be performed before any system IP firm provides any services to entities A or B. The transfer of any portion of any IP assets between entities A and B can be accomplished electronically via system 101 and in particular via IP market place 209. However, entities A and/or B may agree via system 101 to exclusively negotiate more complex agreements or any other agreements or transactions which deviate from those presented via system 101.

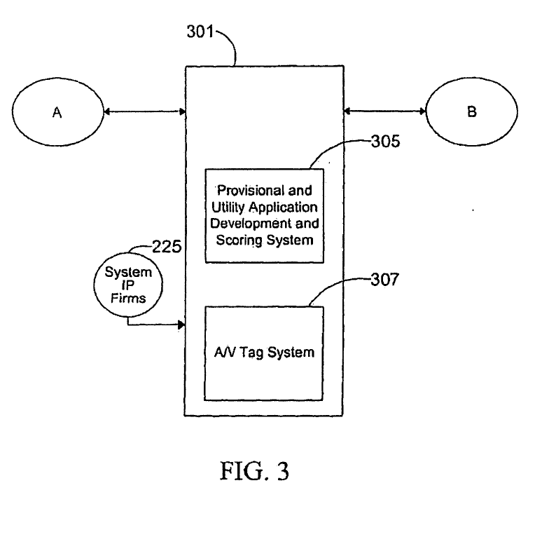

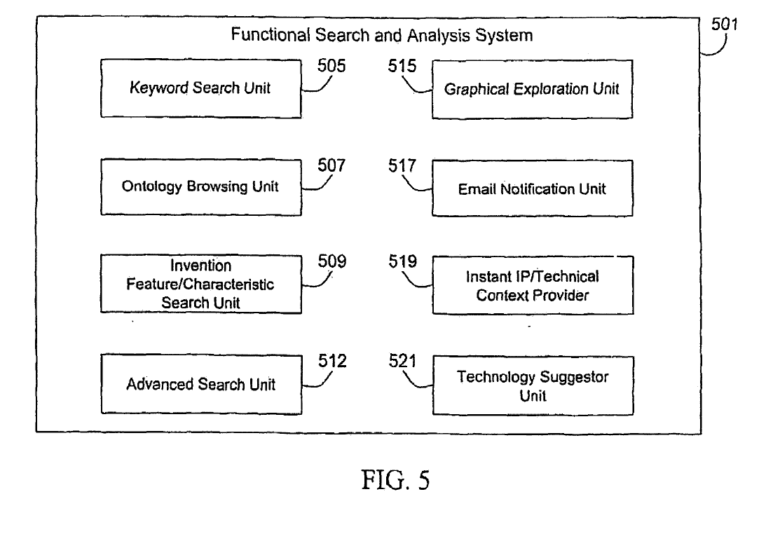

FIG. 3 shows the interactive electronic inventors notebook 301 which includes an interactive provisional and utility patent application development and scoring system 305, a photo, audio and audio/video linking system 307. Users A access the electronic inventors notebook 301 through system 101. Users A are provided invention and prompts a list of technology areas with descriptions and prompts user to select and/or rank the most relevant technology areas or groups of technology areas for the invention. System 305 then provides a tailored invention disclosure form which gives the user guidelines on what information should be included in the invention disclosure document. The invention disclosure forms are tailored to request information relevant to the particular technology areas. The user in turn provides a first draft of the invention disclosure to system 101. System 305 in turn performs an automated analysis of the invention disclosure using search and analysis system 501 (FIG. 5) to provide a parameter corresponding to a potential value of the invention or technology. System 305 further provides an IP scoring number, for example, for 1 to 10 which provides an indication of the likelihood that the provisional application would support claims drawn to the invention in a subsequently filed utility application. The review process could be performed, for example, by system IP firms 225. Using, for example, a scale of 1-10, a 1 would signify that that it is highly unlikely the disclosure would support such claims and a 10 would indicate that it is highly likely that the disclosure would support such claims.

System 301 also includes a photo, audio, video, audio video tag system 307. System 307 can receive any photos, audio information and/or audio video clips (all of which might be referred to 1 as AV tags) from user A describing or demonstrating the invention in the invention disclosure. The AV tag can be used by system IP firms 225 during the ranking process. Also, the AV tag can also be used for entities B to review in the IP market place 209, if user A so indicates. Also, the valuation parameter as parameters from system 501 as well as the IP score from system 307.

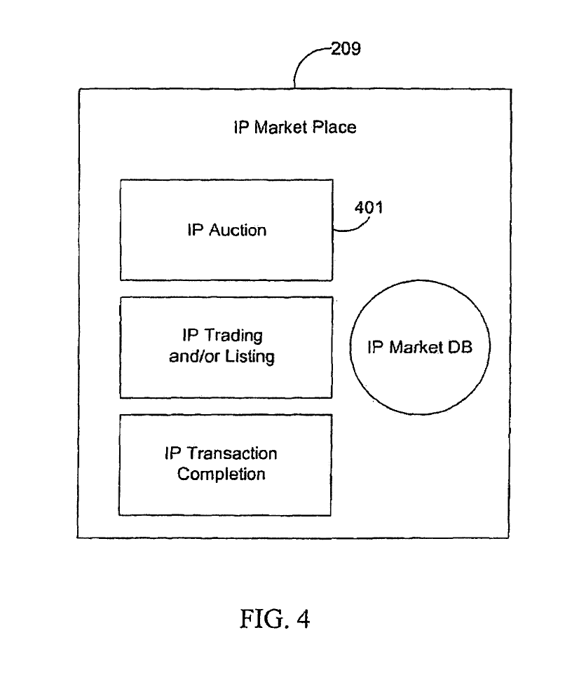

FIG. 4 is a block diagram of the IP marketplace 209, according to an embodiment of the invention. The IP marketplace 209 includes an IP auction system 401, and IP trading system 403 and an IP transaction completion system 405.

The IP auction system 401 provides the IP marketplace 209 with auction capabilities associated with each potential transaction-related feature. The goal of the IP marketplace 209 is to bring the transparency of an open, widely available arid free marketplace to entities A and B, as well as streamline, through automation and services, the transfer of IP from one entity A to entity B in the an efficient manner.

IP trading and listing platform 403 serves as a commodities exchange for IP assets, where the commodities includes IP assets, such as patents, patent applications, provisional patent applications, invention disclosures, trademarks, copyrights, licenses and so forth, as well as derivative instruments for those IP assets, such as futures, options for futures and options to IP assets, and/or combinations or groups of same. The IP and listing platform 403 will make the IP assets themselves, as well as any associated A/V tags and/or predetermined transaction terms accessible to potential purchasers. These are stored in a proprietary IP database (not shown) in system 101.

IP transaction completion system 405 certain IP assets will have predetermined transfer conditions. Those will be available via the IP transaction completion system 405. For example, nonexclusive licenses may be obtained for predetermined terms and associated costs.

FIG. 5 is a block diagram of a functional search and analysis system 501, according to an embodiment of the invention. The system 501 includes keyword searching unit 505, ontology browsing unit 507, feature/characteristic searching unit 509, advanced searching unit 512, graphical exploration unit 515, email notification unit 517, instant IP/technical context provider 519 and technology suggestion unit 521. The function of the units that make the functional search and analysis system 501 will be explained below.

### FOUNDATIONAL SEARCH TECHNOLOGY DEFINITIONS

P) Plain text involves simple indexing of words in documents (and possibly their synonyms and related terms).

O) Ontology involves a detailed classification system allowing for multiple classifications of inventions and descriptive information relating categories to one another in specific ways.

G) Graph-based relationships uses clusters which search system 501 computes to find groups of inventions that appear to be similar or related (making a distinction between similarity and relatedness). Inventions can be analyzed at the group or individual level using information from the graph.

F) Functionally-oriented semantic search—During the disclosure process, inventors describe their invention, including the systems or technologies it is compatible with, and other components that are required for the invention to operate to system 501. System 501 matches up differing terms with the same meaning in order to find technologies that have certain characteristics in common.

U) User tracking—System 501 is capable of tracking individuals and correlates their interests with those of other users. This is optional and only performed with the permission of the user.

### Applications based on Uses of Foundational Search Technologies

1. Basic keyword searching unit 505: A user types words (P) into a search box and hits enter to send to system 501. Unit 505 couples this basic keyword search with the ontology (O) and outputs categories to the user which contain the most bits. In addition, unit 505 can be used with the graph (G) to find very similar inventions that do not contain the same keywords. System 501 is also capable of using functional descriptions to create a set of inventions that perform the same function and to create a list of “invention types” that are relevant to the user's search in order to quickly scope the search to a type of technology. Unit 505 makes use of P and optionally O, G, U and F.

2. Ontology browsing unit 507: A user can browse the ontology, like clicking through categories. Many users may choose this way because they distrust keyword based searching. Ontology browsing unit 507 makes use of O and possibly U.

3. Invention feature/characteristic searching unit 509 (find complementary/competing): A user specifies what a technology does, what components it uses, etc. in order to find a technology based on function. System 501 can then discover inventions that meet the needs from outside fields, identify bundling opportunities, and generally “put the pieces together” from point solutions available on the site. Makes use of P and possibly O in certain cases.

4. Advanced searching unit 512: A user specifies multiple criteria, often combining different Foundational Search Technologies, such as functional characteristics, areas of the ontology to which it belongs, words in the disclosure, inventors, dates, etc. Advanced searching unit 512 makes use of P, O, G and F.

5. Graphical exploration unit 515: Allows a user to see similar technologies available for licensing, and also allows a user to explore related technologies that may be complementary. Graphical exploration unit 515 provides information on assignees, keywords, categories, and the nature of relationships between nodes. Graphical exploration unit 515 makes use of G and O.

6. Email notification unit 517: Allows a user to sign up to track parts of the ontology, keywords, or new inventions with particular functional characteristics. Email notification unit 512 can email new disclosures received that are similar to the user's interests. Email notification unit 517 makes use of: P, O, G and F.

7. Instant IP/technical context provider 519: Provides user with key previous patents in the space, key companies, related categories, etc., while the user is browsing, searching or viewing available technologies. Provider 519 makes use of: G and O.

8. Technology suggestion unit 521: Provides the user with categories of related available technologies and technologies that are competing or complementary in function while the user is browsing. Technology suggestions unit 521 makes use of F, G, O and possibly U.

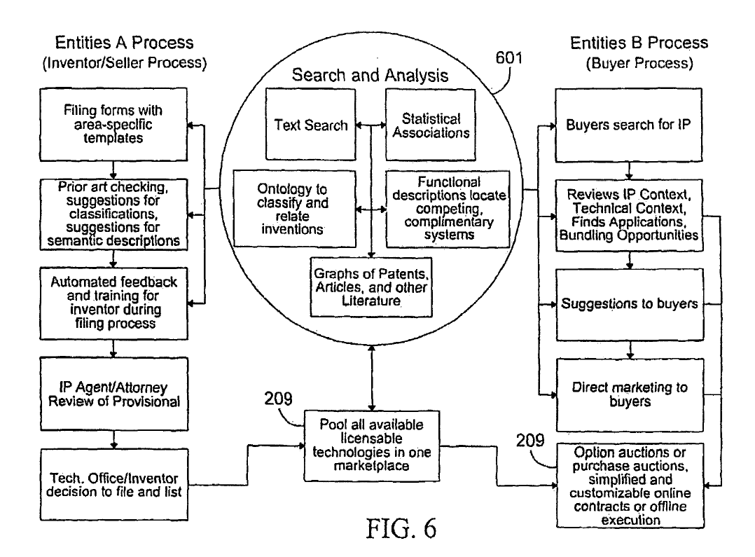

FIG. 6 is a diagram showing exemplary functional relationships available to users of system 601. As shown in FIG. 6, representative services during IP development and marketing exist for entities A (e.g., inventor/seller process). Representative services throughout IP lifetime exist for entities B (e.g., Buyer Process). As shown in FIG. 6, System 601 can interactively enhance operation for entities A and/or B. Accordingly, FIG. 6 shows the internal functionality of search and analysis system 501 as well as some of the external services system 501 provides users A during development of IP and selling of IP and users B during the searching and buying process.

The system 101 provides an efficient marketplace for auctioning intellectual property to maximize value to inventors, universities, industries and others seeking to commercialize their ideas. System 101 can provide a SILENT auction, where individuals could bid over a period of time to either purchase, license (on a non-exclusive or exclusive basis) or option the IP to allow for a specified period of time (say 60-90 days) to negotiate either a purchase or license deal to the intellectual property.

System 101 provides methods of searching, ranking and auctioning IP includes auctioning patents, licenses, trademarks, copyrights, software, etc., and options thereto. Participants do not necessarily have to register ahead of time and pay a registration fee. The auction is open to all comers, and may or may not charge a fee.

As described above, system 101 may include a web-based interface for filing provisional and utility patent applications, design applications, trademark and copyright registration materials associated therewith. The web-interface will provide the exact format for inventors to write down their ideas as required by the national patent office in a provisional, utility, trademarks and other applications. The web-based search and analysis system 501 determines “value” for starting the auction for patents, trademarks or copyright, and for determining patentability by functional search and analysis system 501 which can include, for example:
(1) The number of times a patent is cited
(2) The number of patents issued previously to the inventor
(3) Number of licenses by the inventor (determined by providing a brief questionnaire when the inventors log onto the system 101 or files IP through the web-interface.
(4) Number of existing patents that overlap with description of the proposed or existing patents
(5) System 501 includes a forward looking patentability network that maps existing technology in particular technology areas and can measure the geographic overlap between existing patents are owned where the inventor of the proposed IP is located.
(6) Experts hired to give their opinion.

Features of system 101 include:
a. assigning a value to the technology and/or the IP.
b. providing web-interfaces for inventors to file provisional or utility patent applications, trademarks and/or copyright material in a format that is acceptable to the patent office which may include sample claims language or assistance from system firms 225.
c. providing a web site where inventors or institutions could list their IP and have silent or live auctions where buyers would have the ability to bid over time on the purchase, licenses or options on listed IP.
d. providing a “bid to buy” by clicking on a “buy” button
e. providing a “bid for right to negotiate” a deal by clicking on the “option” button (IP market place 209).
f. providing a “bid to license” by clicking on an exclusive or non-exclusive or both buttons (IP market place 209).
g. provide licenses with set terms where buyers could click through to “set terms”—which can depend on a sliding scale of revenue (ie license for 20K for sales up to 1M 40k for sales up to 5M, 80K. for sales over 10M), and perhaps equity in the case of a startup.
h. buyers could make MULTIPLE offers using system 209 which provides a buy button which can be clicked for offer, then sellers can put in an outright purchase price, click an option to negotiate, and pay a license fee, and click an option to a set of terms for a nonexclusive or exclusive license.
i. The system 101 provides via IP auction 401 in IP market place 209 an interactive competitive auction using shared public or private electronic domains,
j. The system 101 provides interactive collaborative sharing of IP using shared public or private electronic domains,
k. The web interface for system 101 allows for buyers and sellers to click to do, for example, the following licensing:
   i. Exclusive all fields of use—one fee or an auction
   ii. Exclusive in a field-of-use—Fee offline negotiated or auction
   iii. Nonexclusive all fields
   iv. Nonexclusive field-of-use

### Searching Databases

System 101 can serve many purposes for individual inventors, universities, or businesses (for simplicity, all inventor constituents may be designated e-inventor herein), aside from linking inventors to businesses for licensing. For example, system 101 provides each e-inventor with a mechanism for submitting confidential invention disclosures, and a search and analysis system 101 for identifying existing patents and patent applications that correlate highly with a proposed invention. System 101 can return references to such patents from a database such as the USPTO database and allow the e-inventor to further evaluate the viability of the patent. For inventions linked to government contracts, mechanisms for reporting to an appropriate funding source are automated. Furthermore, system 101 can electronically transmit invention disclosures to the IP office of a given company or university, reducing the paperwork and potentially staff required to handle this data internally.

Once an invention disclosure is provided to system 101, search and analysis systems can provide more extensive searching capabilities can determine which companies currently hold patents in related areas and potentially the primary business target as a result. This benefit is two-fold since the e-inventor gains insight into uniqueness or lack-thereof of the proposed invention and some measure of potential businesses that might be interested in the concept. The e-inventor can then decide to submit a provisional application, a full patent application, or neither. The submission of a provisional can be automated by a web-based template and a partnership with one or more IP law-firms willing to handle the filing process. IP law firms and others with business derived from licensing and litigating IP will also be able to advertise on the site. A host of participating patent law firms can be listed to provide e-inventors with options for filing.

Once a provisional or patent application has been filed, the e-inventor can choose to auction an “option” to negotiate a contract. This will effectively allow an e-customer (individual, business or other party interested in licensing) to negotiate a licensing agreement. If the e-customer chooses to remove the patent from the “auction block,” then a fee may be required to do so. However, if the e-customer is willing to leave the IP on the auction block while negotiating, the fee can be reduced or made nominally small. For existing IP being auctioned as a result of bankruptcy liquidation or a conscious decision to exit a certain business market, the auction can be hosted on-line over a defined period as currently takes place on e-bay when an item is auctioned.

The search and analysis system 501 can serve as an incredible resource for the e-inventor, and can be customized so as to provide a metric/score for determining whether or not to proceed with a provisional or patent application as discussed above. Metrics such as uniqueness, the number of patents similar to that proposed, published literature pertinent to the application, business potential, market size, etc. can be used. E-customers can customize the weighting of metrics for their own purposes. This can potentially save significant human resource time. Software required for crawling sites such as Google Scholar, the USPTO database, etc. can be developed as tools for generating the desired information required to construct a metric of evaluation. Once critical existing patents or related literature are identified, extended searches based upon inventors/authors can be used to further understand the existing web-of-knowledge and IP. This data can be presented through concept maps which provide a visual picture of the existing web of patents and interconnections.

It is important to note that the searching mechanism proposed is not limited to the e-inventor. The e-customer, searching for competing technologies or inventions which further differentiate current products might also use the site and search engine. Through such searches initiated by e-customers, IP-Trade can be used to provide e-customers with a sub-list of all inventions on the auction block related to their desired search. As such, the search-engine can further help to link e-inventors with e-customers. When a provisional application is filed, the search engine can “tag” the item by keywords, and notify e-customers of new applications that may be of interest to their business. (Obviously, the e-customer would need to choose to have an automated alert, so as not to be perceived as SPAM).

The information generated in these searches is quite valuable as well and can be maintained as an internal portfolio. For example, if one firm searches for IP relative to HIV vaccines, then this search can be archived and appended as future searches are conducted, but the web of IP generated under the original search need not be repeated. As a result of e-inventor and e-commerce searches conducted, an extensive group of concept maps will result which convey the IP web for a target industry. This can be stored and appropriately tagged to facilitate and expedite future related searches. Furthermore, the concept maps for IP webs can be tied to market potential, yielding a powerful mechanism for evaluating current IP potential as well as predicting areas (both topical and geographical) likely for the next emerging business and investment opportunity. This information will serve valuable to investment bankers, VCs, and others choosing the next major investment opportunity. Obviously, standard practices for evaluating businesses would take place, and the information gained from the concept map would not displace this evaluation process; however, the concept map could be used to assign probabilities for success in IP domains and geographic regions based upon the evolving IP web.

The IP marketplace 109 (the Product) consists of processes, standard and non-standard forms and contracts, associated software and services to assist an IP seller and buyer in List, Find, Research, Bid, Negotiate, Completion (including payment) of IP associated transactions on the web, or its subsequent and related iterations. The Product includes auction capabilities associated with each potential transaction-related feature. The IP market place brings the transparency of an open, widely available and free market place to buyers and sellers of IP, as well as streamline through automation and services the transfer of IP from a seller to a buyer in the most efficient manner.

The system 101 provides at least the following features/functions:

(1) An automated prior art search to assess patentability for an invention or disclosure;

(2) The ability to file a provisional patent application automatically to the U.S. Patent and Trademark Office and/or all other similar offices worldwide;

(3) The ultimate aggregation of all university and commercial IP in one database;

(4) Free access of the IP marketplace for all users;

(5) List features that include, for example, the posting of an available invention and its IP by a seller, indexed in the Product by keywords and phrases, sortable by an array of database attributes that describe the entry;

(6) Find features that include, for example, the searching for an available invention and its IP by a buyer, indexed in the Product by keywords and phrases, sortable by an array of database attributes that describe the entry;

(7) Research features that include, for example, Comment, Communication, Context and Reporting capabilities that will evolve as the system demands. As examples, a user can comment on an IP database listing, communicate with others about a listing, evaluate the context of the listing by assessing an array of other information/material available through or accessible the system, review reports/aggregations of data/information that emanate from the use of the system by others broadly;

(8) Bid/Negotiate features that include, for example, bidding to obtain an option to negotiate on a listing, bidding on specific financial attributes of a transaction associated with a listing; and

(9) Completion features that include, for example, payment and collection of transaction fees and closing fees.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component pans and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A system accessible by a user via the internet, comprising:
a functional search and analysis system;
an e-inventor's notebook operatively coupled to said functional search and analysis system, wherein said functional search and analysis system, said e-inventor's notebook and said IP market place accessible by the user from the internet and provide the user tools to develop its IP and/or sell or purchase partial interests or entire interests in IP assets.
